(19) United States
(12) Patent Application Publication
(10) Pub. No.: US 2016/0329692 A1
(43) Pub. Date: Nov. 10, 2016

(54) BLADE GUARD FOR A HOOKED BLADE OF A CABLE KNIFE

(71) Applicant: KRAMPE Immobilien GmbH & Co. KG, Ascheberg (DE)

(72) Inventor: Carsten BUENNIGMANN, Ascheberg (DE)

(73) Assignee: KRAMPE Immobilien GmbH & Co. KG, Ascheberg (DE)

(21) Appl. No.: 15/137,135

(22) Filed: Apr. 25, 2016

(30) Foreign Application Priority Data
May 6, 2015 (DE) 10 2015 107 022.7

(51) Int. Cl. H02G 1/12; B26B 29/02

(52) U.S. Cl. CPC H02G 1/1229; B26B 29/02

(57) ABSTRACT

A blade guard for a cable knife has a housing as a handle and a hooked blade that projects out at a face side of the housing, which blade can be secured by a protective cover, wherein the hooked blade is attached to the housing in fixed manner, and the protective cover is held in a secured position by a securing slider as a lock, over the hooked blade, and can be pushed into the housing in a working position, counter to a spring force, and when the protective cover springs forward, this slider automatically goes back into the secured position.

### CROSS REFERENCE TO RELATED APPLICATIONS

Applicant claims priority under 35 U.S.C. §119 of German Application No. 10 2015 107 022.1 filed May 6, 2015, the disclosure of which is incorporated by reference.

### BACKGROUND OF THE INVENTION

1. Field of the Invention

The invention relates to a blade guard for a cable knife having a housing as a handle, and a hooked blade that projects out of a face side of the housing and can be secured by means of a protective cover.

2. Description of the Related Art

Cable knives are used for removing the cable sheath of a cable end. For this purpose, a hooked blade is also often provided, if the cable sheath is thicker or quite stiff. The hooked blade is set onto the cable sheath at the cable end, in such a manner that the hook engages under the cable sheath, and now a longitudinal cut is made in the cable sheath, by pulling the hooked blade. Afterward the cable sheath at the cable end can easily be removed.

When using hooked blades, a risk of injury exists if the blade slips off the cable sheath. In order to avoid this risk, to a great extent, it is necessary to provide a blade guard for the hooked blade.

In known cable knives, the blade guard is implemented in that the hooked blade is retracted into the housing in the secured position. Then, there is no risk proceeding from the hooked blade when the cable knife is used with other blades. In the case of a longitudinal cut with the hooked blade, however, the risk of injury continues to exist.

A corresponding cable knife is described in the European patent application EP 1 887 669 B1. The cable sheath removal tool described there has the slitting blade, a spring-loaded clamping bracket, and also a hooked blade. The hooked blade is displaceably mounted in the housing and is pushed out of the housing when needed. Because of the displaceable mounting, the hooked blade does not have a firm seat on the housing, and this lack of a firm seat impairs the guidance of the hooked blade while cutting the cable sheath, and increases the risk of injury. Here, the work is performed with an engagement mechanism, where the blade does not move back in.

### SUMMARY OF THE INVENTION

It is the task of the invention to propose a blade guard for the hooked blade of a cable knife, in which the risk of injury is minimized.

This task is accomplished by a blade guard according to the invention. Advantageous embodiments are indicated below.

The blade guard is intended for a cable knife having a housing as a handle and a hooked blade that projects out of a face side of the housing and can be secured using a protective cover

The blade guard is characterized in that the hooked blade is attached to the housing in fixed manner, and the protective cover is held in a secured position by a securing slider as a lock, over the hooked blade. In this regard, the protective cover can be pushed into the housing counter to a spring force, and automatically goes back into the secured position when the protective cover springs forward.

Therefore, if the hooked blade slides off the cable sheath when the hooked blade is used to make a cut into the sheath, and the resistance of the cable sheath to the spring force of the protective cover is absent, the cover automatically springs forward and secures the hooked blade. As soon as the protective cover covers the hooked blade, no risk of injury proceeds from the blade any longer. The secured position, which has been assumed once again, then locks the protective cover.

The spring force for the protective cover is applied by way of a protective spring disposed in the longitudinal direction of the housing. This spring ensures that the protective cover is pressed back into the secured position in correspondingly rapid manner.

For the working position, the securing slider released by hand and the protective cover is pushed forward up to a depth stop. When the protective cover springs forward, the securing slider is automatically pressed back into the secured position by way of a securing spring, and thereby locks the protective cover over the hooked blade.

The securing slider, in the working position, is held by way of an engagement projection, which engages into a recess of the housing. When the protective cover springs forward, the securing slider is released by way of a slanted plane. The protective spring then presses the securing slider back into the secured position.

For the protective cover, it is advantageous if multiple depth stops are provided in the working position, which stops are predetermined by a depth setter. These stops are defined by different recesses for an engagement projection situated on it in the housing. In this way, the depth setter is used to set how deeply the protective cover can be pressed back into the housing, and to what extent the hooked blade is thereby released. If only a small part of the hooked blade is released in the working position, the risk of injury also becomes less.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a top view of a cable knife, with covered hooked blade and depth setter;

FIG. 2 shows an open housing shell with securing slider;

FIG. 3 shows an open housing shell with details of the blade guard;

FIG. 4 shows details of the secured blade guard;

FIG. 5 shows details of the released blade guard;

FIG. 6 shows setting of the stop depth with a cut housing;

FIG. 7 shows setting of the stop depth with a cut depth setter.

### DETAILED DESCRIPTION OF PREFERRED EMBODIMENTS

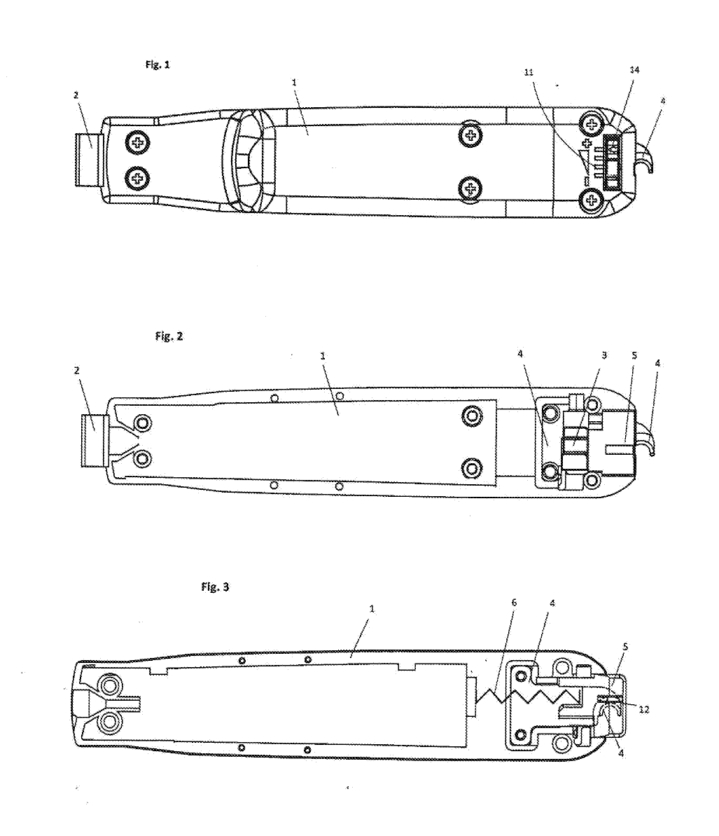

In FIG. 1, a cable knife is shown, in which a hooked blade 4 projects at a face side of the housing 1. On the opposite face side, a further cutting blade is present, which is covered by a clamping bracket 2, For the depth setting of the blade guard, the depth setter 14 is provided with the markings 11.

In FIG. 2 and FIG. 3, an open shell of the housing 1 having the clamping brackets 2 is shown, to which the hooked blade 4 is rigidly attached. The protective cover 5 can slide over the hooked blade 4, counter to the spring force of the protective spring 6, and in this process the protective cover 5 is linearly guided by the guide 12. The securing slider 3 is situated above the hooked blade 4 and, according to FIG. 2, is pushed in, or, according to FIG. 3, is pushed out.

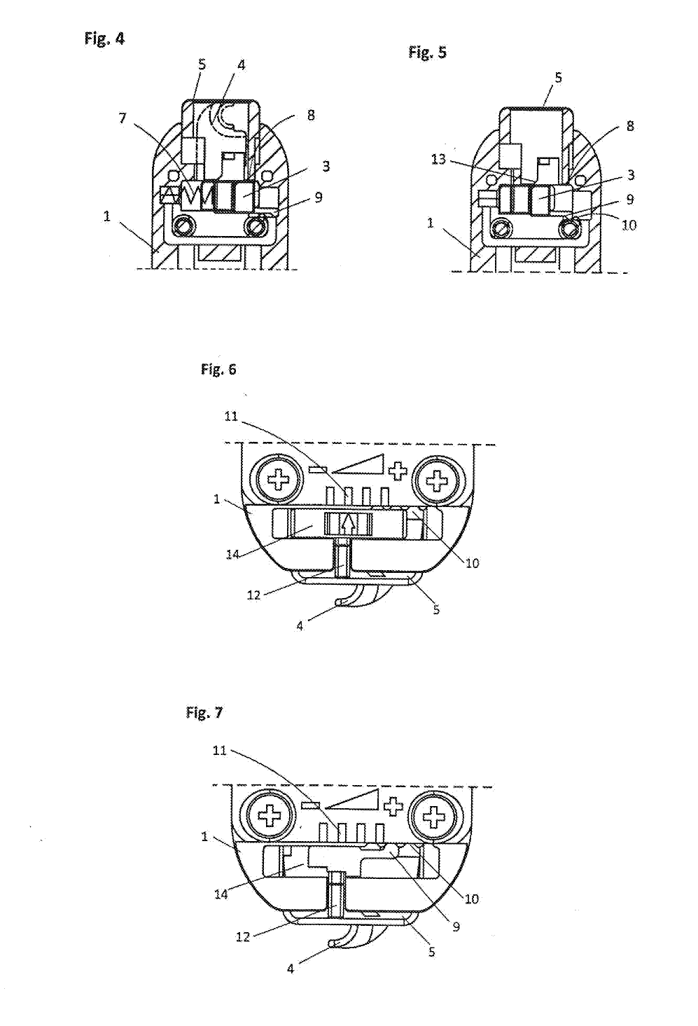

In FIG. 4 and FIG. 5, the details of the blade guard are shown more precisely. In this regard, FIG. 4 shows the locked state, while in FIG. 5, the released state is shown. The hooked blade 4 is rigidly attached to the housing and is covered by the protective cover 5.

According to FIG. 4, the securing slider 3 is pressed into the secured position by way of the securing spring 7. In this process, the protective cover 5 is secured on the securing slider 3 by its locking edge 8. The engagement projection 9 of the depth setter is positioned at the end of its track in the housing 1.

According to FIG. 5, the securing slider 3 is pressed back into the released position. The locking edge 8 can move freely. The engagement projection 9 is held in a recess 10. When the protective cover 5 is pressed in, the securing slider 3 is released by way of the slanted plane 13, and can then be pressed back into the secured position by the securing spring.

In FIG. 6 and FIG. 7, setting of the depth stop is shown in greater detail. In the example shown here, the depth setter 14 is set to the second position, as indicated by the marking 11. In this regard, the protective cover 5 is pushed only partly into the housing 1 by the guide 12, and thereby releases only a part of the hooked blade 4.

According to FIG. 6, in which only the housing is cut, the arrow on the depth setter 14 points to the corresponding marking 11. The different recesses 10 can be seen.

In FIG. 7, in which the depth setter 14 is also cut, it can be seen that the engagement projection 9 can engage into the different recesses 10.

Although only a few embodiments of the present invention have been shown and described, it is to be understood that many changes and modifications may be made thereunto without departing from the spirit and scope of the invention.

What is claimed is:

1. A cable knife blade guard assembly comprising:
(a) a housing forming a handle and having a face side;
(b) a hooked blade attached to the housing in a fixed manner and projecting out at the face side of the housing;
(c) a protective cover securing the hooked blade; and
(d) a securing slider forming a lock and holding the protective cover in a secured position over the hooked blade;
wherein the protective cover is pushable into the housing counter to a spring force in a working position and the securing slider automatically goes back into the secured position when the protective cover springs forward.

2. The cable knife blade guard assembly according to claim 1, further comprising a protective spring disposed in a longitudinal direction of the housing, wherein the spring force for the protective cover is applied by way of the protective spring.

3. The cable knife blade guard assembly according to claim 1, further comprising a securing spring, wherein the securing slider is pushed forward into the working position and, when the protective cover springs forward, the securing slider is automatically pressed back into the secured position, by way of the securing spring.

4. The cable knife blade guard assembly according to claim 3, wherein the securing slider, in the working position, is held by way of an engagement projection, which engages into a recess of the housing, and, when the protective cover springs forward, is pressed out of the recess by way of a slanted plane.

5. The cable knife blade guard assembly according to claim 1, further comprising a depth setter forming a depth stop for the pushed-in protective cover.

6. The cable knife blade guard assembly according to claim 5, wherein the depth setter forms a plurality of depth stops for the protective cover, in the working position, wherein the depth stops are defined by different recesses for the engagement projection in the housing.
